(19) United States
(12) Patent Application Publication
(10) Pub. No.: US 2007/0212651 A1
(43) Pub. Date: Sep. 13, 2007

(54) Method for forming recess on slider surface

(75) Inventors: ShiJun Huang, Dongguan (CN); KarHo Lee, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., HongKong (CN)

(21) Appl. No.: 11/704,387

(22) Filed: Feb. 9, 2007

(30) Foreign Application Priority Data
Feb. 27, 2006 (CN) 200610059918.9

(51) Int. Cl. G03C 5/00; G11B 5/187

(52) U.S. Cl. 430/313; 360/122; 430/320

(57) ABSTRACT

A method for forming recess on slider surface of the invention includes the steps of: coating a sensitizer on the slider; selectively exposing the sensitizer with an exposure intensity of 255-265 mj/cm2 to form an exposure area on the sensitizer; baking the sensitizer for 350-370 seconds; developing the exposure area for 45-55 seconds to remove the sensitizer on the exposure area and to expose the surface of the slider in the exposure area; etching the surface of the slider exposed in the exposure area to form recess on the surface of the slider; finally removing residual sensitizer contained on the surface of the slider.

### FIELD OF THE INVENTION

The present invention relates to a manufacturing method of slider, and more particularly to a method for forming recess on slider surface.

### BACKGROUND OF THE INVENTION

Disk drive units are widely used information storage devices. During data reading/writing operation, a disk contained in the disk drive unit rotates at a high speed such that an air cushion is generated between the disk and a surface of a magnetic read/write head (slider) facing the disk, and the air cushion dynamically floats the slider above the disk, and a certain flying height is maintained for the slider. The surface of the slider facing the disk is generally referred as to air bearing surface (ABS), on the ABS there are several recesses formed. When the disk rotates, an aerodynamic interaction is generated between the recesses and the disk, and a predetermined flying height is maintained between the slider and the disk.

The above recesses on the ABS are commonly formed by photolithography method. FIG. 1 illustrates a process of forming recesses on the ABS using conventional photolithography method. As illustrated, firstly, a kind of sensitizer is coated on a slider; then, the sensitizer is selectively exposed with an exposure intensity of 200 mj/cm² such that a plurality of predetermined exposure areas are formed on the sensitizer; after that, the sensitizer coated on the slider surface is baked for 120 seconds; then, the exposure areas are developed for 70 seconds such that the sensitizer in the exposure areas is removed and the slider surface is exposed in the exposure areas; next, the slider surface exposed in the exposure areas is etched to form recesses thereon; and finally, the residual sensitizer remained on the slider surface is removed.

In the above-mentioned recess forming process, due to insufficient exposure intensity (only of 200 mj/cm²) along with insufficiency of sensitizer baking time (only 120 seconds), an inadequate polymerizing reaction occurs in the sensitizer located in the exposure area during the exposure and baking process, and resultantly the sensitizer remains in the exposure area and forms a pileup region during a subsequent developing process, other than be cleared away by developing solvent. The pileup region is shown in FIG. 4A. As illustrated, a big pileup region 13 is defined at a location where a slider 12, a photosensitive layer 16 and an exposure area 162 are joined together. The pileup makes the etching rate of the area around the pileup region different from that of the area apart from the pileup region during subsequent etching process, thus making the slider surface having different etching depth. That is, the recess formed by etching is unable to obtain a vertical sidewall. FIG. 5A shows a recess formed on a slider surface by conventional photolithography method. As illustrated, a large slope angle is defined between a sidewall 152 of the recess 15 provided on the slider 12 and a direction perpendicular to the slider surface, and normally, the slope angle may rise to 85 degrees. The larger slope angle makes the recess shape differs more greatly from its ideal shape (in ideal condition, the sidewall is perpendicular to the slider surface), and accordingly, makes the slider have a flying height different from its design value during flying process, and in some case may even have a flying height beyond an allowed tolerance range of design value. Therefore, the slider cannot obtain an accurate flying height so that data reading/writing performance of the slider is greatly affected. Also, an insufficient baking time consumed in baking the sensitizer results in a weak adhesion between the sensitizer and the slider surface, thus making the photosensitive layer constructed by the sensitizer susceptible to deformation and even peeling off from the slider, thereby leading to failure of photolithography. In addition, since the developing time in conventional recess forming method is too long (70 seconds), overdeveloping may occur easily, i.e., unexposed portion around the exposure area is also cleaned away partially such that a shape of the exposure area is changed, thereby making the recess thus formed have a rough sidewall, and a high fencing having a height of 2 nm and a width of 2.5 nm being formed on bottom of the recess. The rough sidewall contains a great number of particles. When the disk operates, the particles may easily fall on the disk and scratch the disk surface; moreover, the fencing may also scratch the disk surface when the disk is in operation, thereby leading to disk and/or slider damage.

Thus, there is a need for an improved recess forming method that does not suffer from the above-mentioned drawbacks.

### SUMMARY OF THE INVENTION

One aspect of the present invention is to provide a method for forming recess on slider surface, which can improve flying stability of the slider by properly adjusting exposure intensity, baking time and developing time for forming the recess so at to attain a vertical sidewall.

Another aspect of the present invention is to provide a method for forming recess on slider surface, which can avoid disk/slider scratch by properly adjusting exposure intensity, baking time and developing time for forming the recess so as to a smooth sidewall and bottom portion.

Another aspect of the present invention is to provide a method for forming recess on slider surface, which can assure the photosensitive layer firmly stuck to the slider surface during recess forming process, while neither deformation nor peeling off from the slider will happen to the photosensitive layer, by properly extending the baking time.

To achieve the above objects, a method for forming recess on slider surface of the invention comprises the steps of: coating a kind of sensitizer on the slider; selectively exposing the sensitizer with an exposure intensity of 255-265 mj/cm² to form an exposure area on the sensitizer; baking the sensitizer for 350-370 seconds; developing the exposure area for 45-55 seconds to remove the sensitizer provided on the exposure area and to expose the surface of the slider in the exposure area; etching the surface of the slider exposed in the exposure area to form recess on the surface of the slider; finally, removing residual sensitizer contained on the surface of the slider.

Preferably, the exposure intensity is 260 mj/cm²; the baking time for the sensitizer is 360 seconds; and the developing time is 50 seconds.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 shows a flowchart of forming recess on slider surface using a conventional method;

FIG. 2 shows a flowchart of forming recess on a slider surface using a method according to an embodiment of the invention;

FIGS. 3A-3E are sequential views corresponding to the flowchart of the method shown in FIG. 2, illustrating a recess forming process according to an embodiment of the invention;

FIG. 4A shows a big pileup region formed by residual sensitizer and caused by the conventional recess forming method;

FIG. 4B shows a partially enlarged view of portion C of the structure shown in FIG. 3D, illustrating a small pileup formed by recess forming method of the invention;

FIG. 5A shows a recess with a clear slope sidewall formed by the conventional recess forming method;

FIG. 5B shows a partially enlarged view of portion D of the structure shown in FIG. 3E, illustrating a recess with a vertical sidewall formed by recess forming method according to an embodiment of the invention;

FIG. 6 shows a perspective view of a recess viewed via a nano-microscope and formed by the recess forming method of the invention;

FIG. 7 shows a side view of the recess shown in FIG. 6; and

FIG. 8 shows a top plan view of the recess shown in FIG. 6.

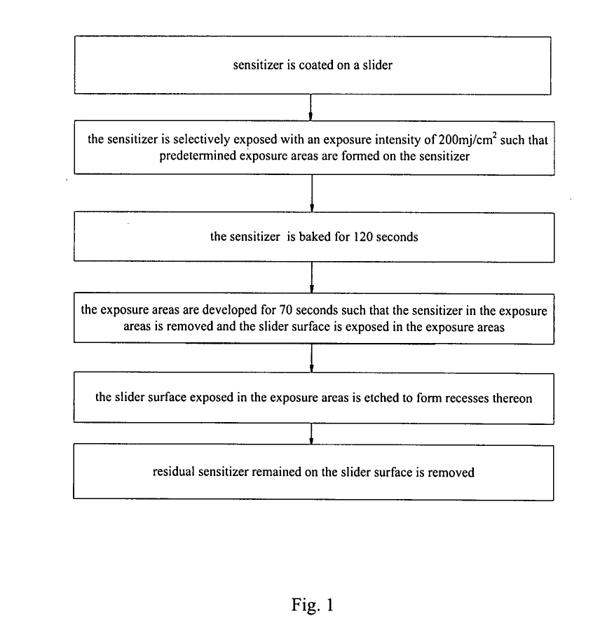

### DETAILED DESCRIPTION OF ILLUSTRATED EMBODIMENTS

Various preferred embodiments of the instant invention will now be described with reference to the figures. As illustrated, the invention provides a method for forming recess on a surface of a slider. By properly adjusting technical conditions of recess forming process, more specifically, by suitably improving exposure intensity in exposure process, extending the time for baking sensitizer after exposure, and shortening developing time, the recess so-formed can obtain a vertical and smooth sidewall, and no fencing is formed on the bottom of the recess. In other words, the formed recess has higher dimension accuracy so as to make the slider have a more ideal flying height when flying above a disk. For example, the slider may have a flying height at write gap and read gap more similar to its designed value, thereby improving flying performance of the slider. In addition, the smooth sidewall and bottom of the recess make sure that a slider/disk scratch will not happen during slider flying above the disk. Moreover, by extending the baking time for the sensitizer after exposure, the sensitizer coated on the slider surface is not easy to deform or peel off from the slider, thus not affecting implementation of the following process.

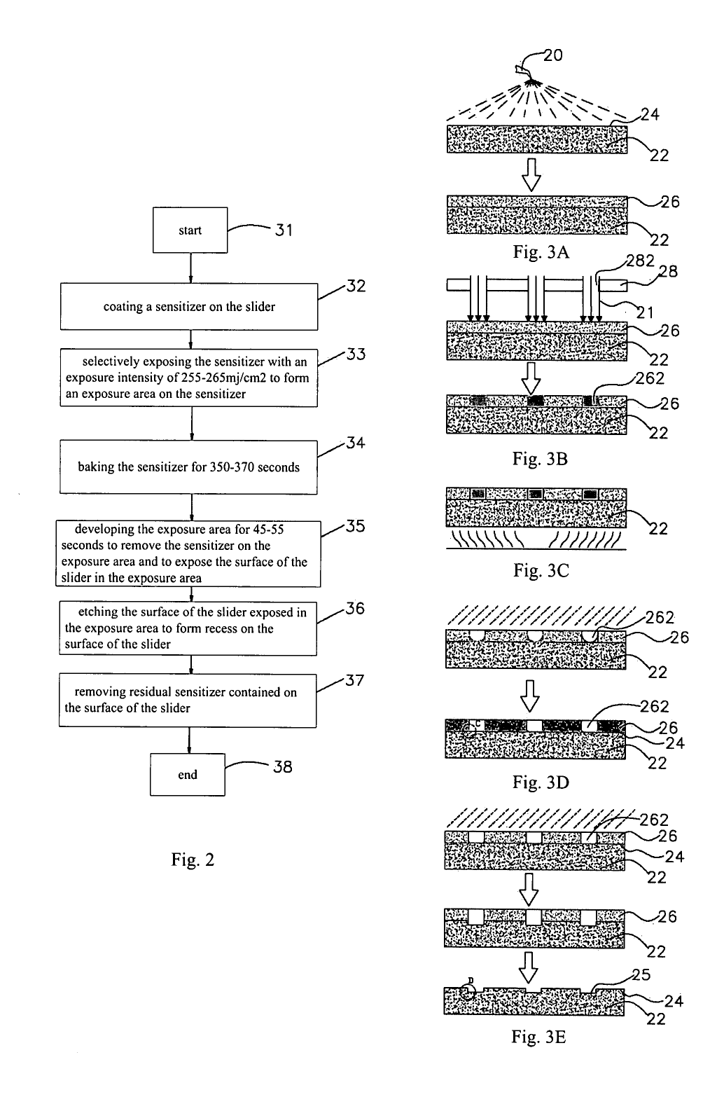

Now various embodiments of the invention will be described. FIG. 2, FIGS. 3A-3E, FIG. 4B, FIG. 5B and FIGS. 6-8 illustrate an embodiment of the invention. FIG. 2 shows a flowchart of forming recess on slider surface using a method according to the embodiment of the invention. FIGS. 3A-3E are sequential views corresponding to the flowchart of the method shown in FIG. 2, illustrating a recess forming process according to an embodiment of the invention.

Referring to FIG. 2, when the forming process starts (step 31), firstly a sensitizer is coated on a slider (step 32). Referring to FIG. 3A, the sensitizer in solution-form is sprayed to a surface 24 (a surface for forming an ABS) of the rotating slider 22 via a nozzle 20. Due to rotation of the slider 22 at a high speed, the sensitizer solution is uniformly coated on the surface 24 and a photosensitive layer 26 is formed thereon. Then, selectively the sensitizer is exposed with exposure intensity of 255-265 mj/cm² to form exposure areas on the sensitizer (step 33 of FIG. 2). More specifically, referring to FIG. 3B, a reticle 28 having a plurality of holes 282 is positioned above the photosensitive layer 26, then the holes 282 is irradiated by a light source 21 with exposure intensity of 255-265 mj/cm² such that light passes though the holes 282 and reaches the photosensitive layer 26. Thus, exposure areas 262 on the photosensitive layer 26 are formed with the shape and location of the exposure areas 262 being consistent with that of the holes 282. Also referring to FIG. 3C, the sensitizer is baked for 350-370 seconds (step 34). Next, the exposure areas are developed for 45-55 seconds to remove the sensitizer in the exposure areas and to expose the surface of the slider in the exposure area (step 35 of FIG. 2). Concretely, as shown in FIG. 3D, the exposure areas 262 are cleaned by a developing solvent (not shown) so as to dissolve the sensitizer therein and make the surface 24 of the slider 22 exposed in the cleaned exposure areas 262. Thereafter, the surface of the slider exposed in exposure areas is etched such that a recess is formed on the surface of the slider (step 36 of FIG. 2). Referring to FIG. 3E, the recess 25 is formed on the surface 24 by etching the surface 24 of the slider 22 exposed in the exposure areas 262. Next, residual sensitizer contained on the surface of the slider is removed (step 37 of FIG. 2), and the whole manufacturing process is ended (step 38 of FIG. 2).

In the embodiment, the sensitizer may be any suitable photosensitive material. Furthermore, the sensitizer may be coated on the surface of the slider by any other suitable manner. The light source may be an ultraviolet source having a wavelength of 365 nm, which is generated by high-pressure mercury lamp. Selectively, the light source may be deep ultraviolet source (DUV), X-ray, electron beam, or a light source generated by excimer laser device. The developing solvent may be any suitable developing solution, for example sodium hydroxide solution. The etching process may be implemented by reactive ion etching (RIE) method.

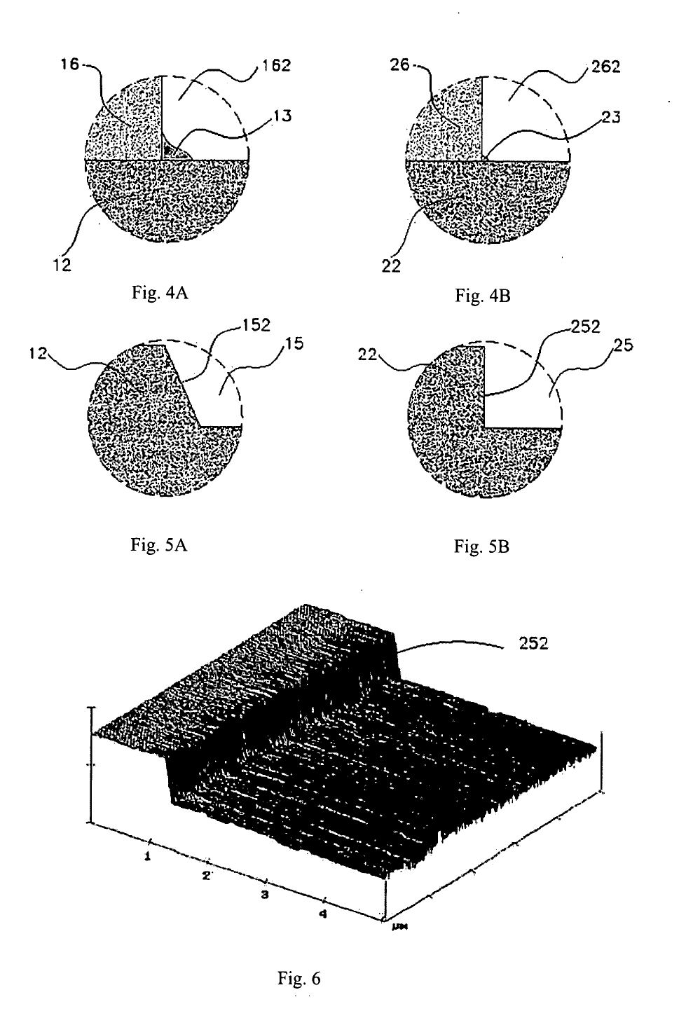

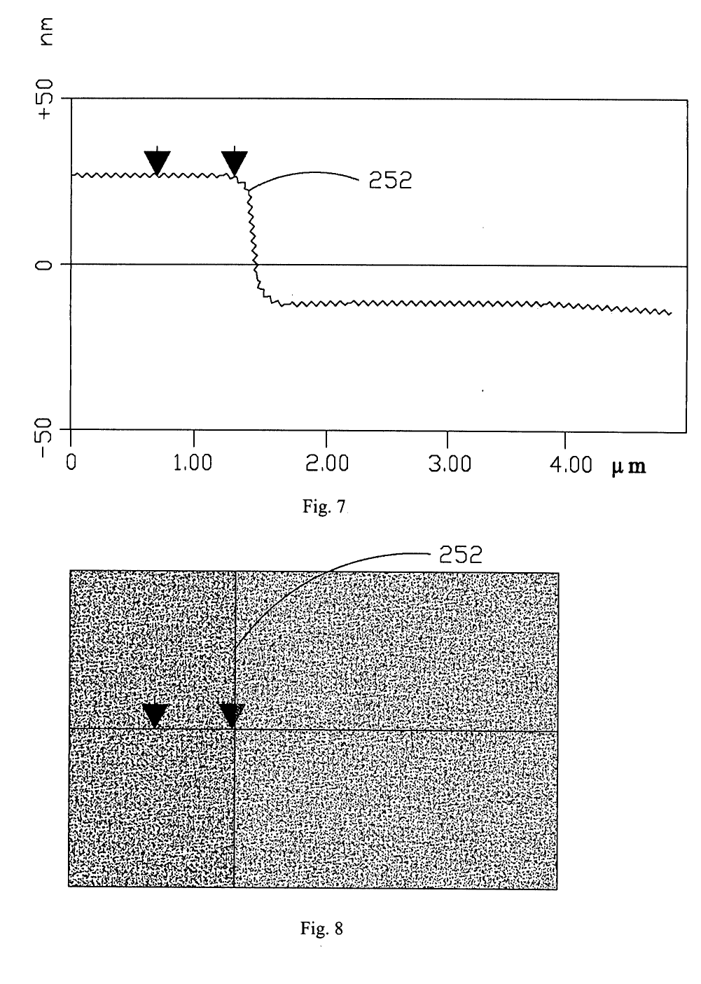

In the embodiment, increasing exposure intensity to 255-265 mj/cm² and setting the baking time to 350-370 seconds can ensure more sufficient polymerizing reaction in the sensitizer of the exposure areas, thus leading to complete cleanout of the sensitizer in the exposure areas during subsequent developing process. FIG. 4B shows a partially enlarged view of portion C of the slider surface after completion of the step shown in FIG. 3D (step 35 of FIG. 2). As illustrated, compared with conventional technology shown in FIG. 4A, a very small pileup region 23 is formed among the slider 22, the photosensitive layer 26 and the exposure area 262. The small pileup 23 has little or even no influence on later etching process. FIG. 5B shows a partially enlarged view of portion D of the slider surface after completion of the step shown in FIG. 3E (step 36 of FIG. 2). As shown in the figure, compared with conventional technology shown in FIG. 5A, the recess 25 formed on the slider 22 has a vertical sidewall 252. In addition, a longer baking time ensures that the photosensitive layer is stick to the slider surface firmly, and neither deformation nor peeling off from the slider will occur to the photosensitive layer. Moreover, by adjusting developing time to 45-55 seconds, overdevelopment is avoided, thereby the recess so-formed having a smoother sidewall and no fencing being formed on the bottom of the recess, and therefore, no disk/slider scratch occurs during the slider flying process. FIG. 6 shows a perspective view of a recess formed by a method of the invention and viewed via a nano-microscope, and FIGS. 7-8 show a side view and top plan view of the recess shown in FIG. 6 respectively. It is noted from the figures that the method for forming recess on slider surface provided by the invention can form a recess having a very vertical sidewall 252, and the sidewall and the bottom thereof are perfectly smooth.

The vertical sidewall of the recess on the slider surface helps to improve flying performance of the slider. The following table demonstrates slider flying experimental data of both conventional technology and the invention. In the table, the flying parameter includes flying heights at write gap and read gap, and data includes maximum flying height, minimum flying height, mean flying height, standard variation, and number of the tested sliders.

| Group | Amount | Item | Write gap | Read gap |
|---|---|---|---|---|
| The invention | 39 | Mean value | 7.609 | 7.784 |
| | | Standard variation | 0.758 | 0.75 |
| | | Minimum value | 5.916 | 6.093 |
| | | Maximum value | 9.52 | 9.546 |
| Group | Number | Item | Write gap | Read gap |
| Conventional | 40 | Mean value | 7.852 | 8.033 |
| technology | | Standard variation | 0.885 | 0.878 |
| | | Minimum value | 5.843 | 6.023 |
| | | Maximum value | 11.059 | 11.185 |

It is clear from the table that the stand variation of the flying height at write gap and read gap of the slider of the invention is lower in excess of 0.1 than the conventional technology. Namely, the invention attains a more stable flying performance.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method for forming recess on slider surface, comprising the steps of:
(1) coating a kind of sensitizer on the slider;
(2) selectively exposing the sensitizer with an exposure intensity of 255-265 mj/cm² to form an exposure area on the sensitizer;
(3) baking the sensitizer for 350-370 seconds;
(4) developing the exposure area for 45-55 seconds to remove the sensitizer on the exposure area and to expose the surface of the slider in the exposure area;
(5) etching the surface of the slider exposed in the exposure area to form recess on the surface of the slider; and
(6) finally removing residual sensitizer contained on the surface of the slider.

2. The method as claimed in claim 1, wherein the selective exposure in the step (2) is realized by irradiating a reticle having a hole via a light source.

3. The method as claimed in claim 2, wherein the light source is ultraviolet light source having a wavelength of 365 nm, which is generated by a high-pressure mercury lamp.

4. The method as claimed in claim 2, wherein the light source is a deep ultraviolet light source having a wavelength of 248 nm generated by a high pressure mercury lamp, X-ray, electron beam, or a light source generated by, or excimer laser.

5. The method as claimed in claim 1, wherein the exposure intensity is 260 mj/cm², the time for baking the sensitizer is 360 seconds, and the developing time is 50 seconds.
